(19) United States
(12) Patent Application Publication
(10) Pub. No.: US 2008/0153428 A1
(43) Pub. Date: Jun. 26, 2008

(54) Apparatus and method for transmitting/receiving feedback information in a mobile communication system using array antennas

(75) Inventors: Jin-Kyu Han, Seoul (KR); Hwan-Joon Kwon, Hwaseong-si (KR); Seung-Kyun Oh, Suwon-si (KR); Dong-Hee Kim, Yongin-si (KR); Jae-Chon Yu, Suwon-si (KR); Yeon-Ju Lim, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/999,511

(22) Filed: Dec. 4, 2007

(30) Foreign Application Priority Data
Dec. 4, 2006 (KR) 121499-2006
Dec. 5, 2006 (KR) 121900-2006

(51) Int. Cl. H04B 1/00; H04B 7/00

(52) U.S. Cl. 455/69; 455/403

(57) ABSTRACT

Provided is a method for transmitting feedback information by a receiver in a mobile communication system that performs multiplexing transmission using array antennas. The method includes determining a weight set for maximizing a data rate among at least one weight set having, as its elements, multiple orthonormal weight vectors, based on a fading channel estimated from a pilot channel of received data; estimating channel state information corresponding to a weight vector of the determined weight set; and generating and transmitting feedback information including an index of the determined weight set, the selected weight vector information, and the channel state information corresponding to the weight vector.

### PRIORITY

This application claims priority under 35 U.S.C. § 119(a) to a Korean Patent Application filed in the Korean Intellectual Property Office on Dec. 4, 2006 and assigned Serial No. 2006-121499, and a Korean Patent Application filed in the Korean Intellectual Property Office on Dec. 5, 2006 and assigned Serial No. 2006-121900, the disclosures of both of which are incorporated herein by reference.

### BACKGROUND OF THE INVENTION

1. Field of the Invention

The present invention relates generally to an apparatus and method for transmitting/receiving data in a mobile communication system, and in particular, to a data transmission/reception apparatus and method for realizing spatial multiplexing transmission in a mobile communication system using transmit/receive array antennas.

2. Description of the Related Art

Mobile communication systems have evolved from the early communication system for mainly providing the voice services, into the high-speed, high-quality wireless data packet communication system for providing the data services and multimedia services. Standardization for High Speed Downlink Packet Access (HSDPA) by 3^{rd} Generation Partnership Project (3GPP) and standardization for 1x Evolution-Data and Voice (1xEV-DV) by 3^{rd} Generation Partnership Project-2 (3GPP2) are typical attempts to find a solution for the high-speed, high-quality wireless data packet transmission service at a rate of 2 Mbps or higher in the 3^{rd} Generation mobile communication system. Meanwhile, the 4^{th} Generation mobile communication system aims at providing the high-speed, high-quality multimedia services at a much higher rate.

In the wireless communication system, a spatial multiplexing transmission technique based on the Multiple-Input Multiple-Output (MIMO) antenna system that uses multiple antennas in a transmitter and a receiver has been proposed to provide the high-speed, high-quality data services. The spatial multiplexing transmission technique simultaneously transmits different data streams via transmit antennas separately, so, theoretically, the serviceable data capacity linearly increases with an increase in the number of transmit/receive antennas without further increasing the frequency bandwidth.

The spatial multiplexing transmission technique provides a higher capacity in proportion to the number of transmit/receive antennas when fading between transmit/receive antennas is independent. However, in an environment where a spatial correlation of the fading is higher, the spatial multiplexing transmission technique suffers from a considerable reduction in capacity compared to the independent-fading environment. This is because if a correlation of fading between transmit/receive antennas increases, the fading that the signals transmitted from the transmit antennas experience is similar, so the receiver can hardly distinguish the signals on a spatial basis. In addition, the available transmission capacity is affected by a Signal-to-Noise Ratio (SNR) of the receiver, and the transmission capacity decreases with a decrease in the received SNR. Therefore, to maximize a transmission data rate, it is necessary to adjust a wireless channel state between a transmitter and a receiver, i.e., a spatial correlation of fading, the number of data streams simultaneously transmitted according to the received SNR, and a rate of each data stream. If the desired transmission data rate exceeds the transmission capacity supportable by the wireless channel, many errors may occur due to the interference between the simultaneously transmitted data streams, causing a reduction in the actual data rate.

Accordingly, intensive researches on a Precoding technique have been conducted to increase the transmission data rate of the spatial multiplexing transmission technique. The Precoding technique multiplies transmission data streams desired by a transmitter by transmission weights, using downlink channel information from the transmitter to the receiver, before transmission. Therefore, the transmitter should previously have information on the downlink channel states from transmit antennas of the transmitter to receive antennas of the receiver. To this end, the receiver should estimate downlink channel states, and then feed back the estimated downlink channel state information to the transmitter over a feedback channel. However, as the receiver uses an uplink feedback channel to feed back the downlink channel state information to the transmitter, the amount of feedback data increases. If the transmission-required amount of feedback data increases, the receiver requires a long time for feeding back the downlink channel state information to the transmitter using the bandwidth-limited uplink feedback channel, making it impossible to apply the Precoding technique to the instantaneously varying wireless channel environment. Therefore, there is a need for a technology that maximizes the data rate by Precoding, while minimizing the amount of feedback data transmitted from the receiver to the transmitter.

A Precoder Codebook technique has been proposed as the conventional technology for reducing the amount of feedback information. In the Precoder Codebook technique, the receiver determines a precoder having the maximum rate among the candidate precoders in a precoder codebook (or precoder set) composed of a predetermined number of precoders, known by the transmitter and the receiver, and feeds back an index of the determined precoder to the transmitter. The transmitter transmits data using a precoder corresponding to the feedback index in the precoder codebook. For example, when 4-bit feedback information is used, a precoder codebook composed of a maximum of 2⁴=16 precoders is preset between the transmitter and the receiver. However, because the fading varies with the passage of time, the precoder determining process must be repeated every slot, and the receiver feeds back the precoder index determined every slot, to the transmitter every slot.

As described above, the Precoder Codebook technique produces less feedback information than the Precoding technique that transmits the feedback channel state information. That is, for example, in the Multiple-Input/Multiple Output (MIMO) antenna system with n_{T} transmit antennas and n_{R} receive antennas, the receiver should feed back a total of n_{T}×n_{R} complex channel coefficients when feeding back the channel state information. Therefore, if Q bits are required for indicating one complex channel coefficient, a total of n_{T}×n_{R}×Q_{bit} bits are required.

On the contrary, in the Precoder Codebook technique, if the number of precoders used for providing the sufficient data rate is K, ┌ log₂ K┐ bits are required, where ┌x┐ denotes an integer, which is greater than or equal to ‘x’.

Therefore, unlike the channel state information-based Precoding technique in which the amount of feedback information increases with a product of the number of transmit antennas and the number of receive antennas, the Precoder Codebook technique determines the amount of feedback information depending on the number of precoders included in the precoder codebook, i.e. the size of the precoder codebook, regardless of the number of transmit antennas and the number of receive antennas. The Precoder Codebook technique quantizes precoders for all possible cases occurring during spatial multiplexing transmission, and includes the ready-made precoders in the codebook.

The Precoder Codebook technique can reduce the amount of feedback information with the use of the predetermined precoders, but reduces even the degree of freedom for a precoding matrix. The reduction in the degree of freedom for the precoding matrix, when there are many factors that should be considered, dramatically increases the number of the predetermined precoders, causing an increase in the size of the precoder codebook. The codebook size of the Precoder Codebook technique may dramatically increase in the following two cases.

First, to apply the Precoder Codebook technique to the channel environment having various spatial correlations, all precoders based on the various spatial correlations of the channels should be considered, causing an exponential increase in the number of the precoders that should be considered. That is, the optimal precoder codebook varies according to the spatial correlations of the channels. The proposed Precoder Codebook technique designs the precoder codebook on the assumption that the fading channels have no spatial correlation. However, distribution of valid eigenvectors, i.e., eigenvectors having a great eigenvalue, varies according to the spatial correlations of the fading channels, so the optimal precoders are also subject to change. That is, to obtain the high data rate, a large number of precoder codebooks optimized according to the various spatial correlations of the fading channels should be used.

Second, when the number of simultaneously transmitted data streams is adjusted according to the channel environments, all precoders corresponding to the number of simultaneously transmitted data streams should be considered, causing an exponential increase in the number of the precoders that should be considered. The number of simultaneously transmitted data streams varies from 1 to a maximum of min(n_{T},n_{R}) (indicating the lesser of the number of transmit antennas and the number of receive antennas) according to the channel environment. The number of columns of the precoder matrix should be changed according to the number of simultaneously transmitted data streams for the following reason. That is, because column vectors constituting the precoder matrix are multiplied by data streams as weight vectors, the number of column vectors of the precoder matrix should be identical to the number of simultaneously transmitted data streams. For example, when both the number of transmit antennas and the number of receive antennas are 4, the number of simultaneously transmittable data streams varies from 1 to 4, so consideration should be given to the precoders having 1 column vector, the precoders having 2 column vectors, the precoders having 3 column vectors, and the precoders having 4 column vectors. In addition, when the maximum number of simultaneously transmittable data streams increases due to the increase in the number of transmit antennas and the number of receive antennas, a considerably great amount of feedback information is required due to the increase in the number of the precoders that should be considered. Therefore, it is difficult to apply the Precoder Codebook technique to the spatial multiplexing transmission scheme that intends to achieve the maximum rate in the corresponding channel environment by varying the number of simultaneously transmitted data streams and the transmission data rate according to the channel environment. As described above, the Precoder Codebook technique using the set of predetermined precoders increases the size of the precoder codebook according to the number of transmit antennas and the number of simultaneously transmitted data streams, making its application difficult.

In addition, the receivers in communication with one transmitter can each use a different number of antennas. For example, when there are 4 antennas in the transmitter (or base station) and one of 1, 2, 3, and 4 antennas in each of the receivers (or mobile stations), according to the type of the mobile stations, the maximum number of transmittable sub-data streams is one of 1, 2, 3 and 4, respectively. Therefore, the Precoder Codebook technique, for its application, should define precoder codebooks according to all possible numbers of receiver's antennas, respectively, and define their associated feedback channels accordingly. The receivers each should select a precoder codebook and its associated feedback channel according to the number of antennas of the corresponding receiver. This needs a process for defining precoder codebooks and their associated feedback channels to be used between the transmitter and the receiver, and also needs feedback information. Therefore, there is a need for a flexible Precoding technique that can be applied to various transmit/receive antenna structures.

In conclusion, there is a need for research on efficient Precoding schemes and feedback schemes that can be applied to the spatial multiplexing transmission scheme that adjust the number of simultaneously transmitted data streams according to the channel environment in the channel environment having various spatial correlations, and can also provide a high data rate with a very small amount of feedback information.

### SUMMARY OF THE INVENTION

An aspect of the present invention is to address at least the problems and/or disadvantages and to provide at least the advantages described below. Accordingly, an aspect of the present invention is to provide a data transmission/reception apparatus and method for efficiently providing a data rate according to the channel environment in a mobile communication system using transmit/receive array antennas.

Another aspect of the present invention is to provide a data transmission/reception apparatus and method for providing a high data rate with a small amount of feedback information in a mobile communication system using transmit/receive array antennas.

Another aspect of the present invention is to provide an apparatus and method for generating efficient feedback information in a mobile communication system using transmit/receive array antennas.

According to one aspect of the present invention, there is provided a method for transmitting feedback information by a receiver in a mobile communication system that performs multiplexing transmission using array antennas. The method includes determining a weight set for maximizing a data rate among at least one weight set having, as its elements, multiple orthonormal weight vectors, based on a fading channel estimated from a pilot channel of received data; estimating channel state information corresponding to a weight vector of the determined weight set; and generating and transmitting the feedback information including an index of the determined weight set, the selected weight vector information, and the channel state information corresponding to the weight vectors.

According to another aspect of the present invention, there is provided a method for receiving feedback information by a transmitter in a mobile communication system that performs multiplexing transmission using array antennas. The method includes receiving a weight set for maximizing a data rate among at least one weight set having, as its elements, multiple orthonormal weight vectors, and selected weight vector information; receiving sub-channel data stream state information; and mapping the received sub-channel data stream state information in an order of the selected weight vectors.

According to another aspect of the present invention, there is provided a reception apparatus for transmitting feedback information in a mobile communication system that performs multiplexing transmission using array antennas. The reception apparatus includes a downlink channel estimator for estimating a channel state using a pilot channel of data transmitted from a transmitter; a weight selector for determining a weight set and a weight vector based on the channel state, and transmitting information on the weight set and the weight vector to the transmitter; and a sub-channel state estimator for estimating a sub-data channel state according to the determined weight vector, and transmitting the sub-data channel state to the transmitter.

### BRIEF DESCRIPTION OF THE DRAWINGS

The above and other aspects, features and advantages of the present invention will become more apparent from the following detailed description when taken in conjunction with the accompanying drawings in which:

FIG. 1 illustrates architecture of a system according to an embodiment of the present invention;

FIG. 2 illustrates a data transmission/reception method performed in a receiver of the system according to an embodiment of the present invention;

FIG. 3 illustrates a data transmission/reception method performed in a transmitter of the system according to an embodiment of the present invention;

FIGS. 4 and 5 illustrate a method for determining weight sets in the system according to an embodiment of the present invention;

FIG. 6 illustrates a process of setting and rearranging sub-data stream state information according to the number of selected weight vectors;

FIG. 7 illustrates a process of receiving, by a transmitter, sub-data stream state information according to the number of selected weight vectors, and mapping it to the selected weight vectors;

FIG. 8 illustrates a performance comparison result between the conventional technique and the proposed system in a spatial correlation environment; and

FIG. 9 illustrates a performance comparison result between the conventional technique and the proposed system in a no-spatial correlation environment.

### DETAILED DESCRIPTION OF THE PREFERRED EMBODIMENTS

Preferred embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness.

The present invention provides an apparatus and method in which for a data rate, a transmitter receives predetermined feedback information from a receiver according to a spatial correlation and efficiently uses the received feedback information in a system using multiple transmit/receive antennas.

In brief, in the system of the present invention using multiple transmit/receive antennas, the receiver selects a weight set for maximizing the data rate among a predetermined number of weight sets, selects weights in the set, and transfers the selected information to the transmitter over an uplink feedback channel. The transmitter generates a precoding matrix using the information (feedback information) transmitted from the receiver over the feedback channel. Here, the feedback information can include an index of the weight set, weight vector information for the weights selected in the set, and channel state information for each sub-data stream (hereinafter, “sub-data stream's channel state information” or “sub-data stream state information”). Herein, the information including the index of the weight set, the weight vector information, and the sub-data stream's channel state information is defined as feedback information. In addition, the foregoing technology of the present invention will be referred to as a ‘Knockdown Precoding technology’.

A system according to the present invention and a method for generating feedback information will now be described.

1) Knockdown Precoding System

The present invention is based on a Multiple-Input Multiple-Output (MIMO) antenna system in which a transmitter has a transmit array antenna with n_{T} antennas arrayed therein, and a receiver has a receive array antenna with n_{R} antennas arrayed therein. The transmitter and the receiver predetermine and predefine a plurality of weight sets. The weight set is a set having, as its elements, as many weight vectors as the number of transmit antennas, and when N weight sets are determined, a total of N×n_{T} weight vectors are determined.

In the Knockdown Precoding technology, the receiver selects one weight set for maximizing the data rate among a predetermined number N of weight sets, selects weights in the set, and transfers an index of the selected weight set and weight vector information for the selected weights in the set to the transmitter over an uplink feedback channel, and the transmitter generates a precoding matrix using the feedback information.

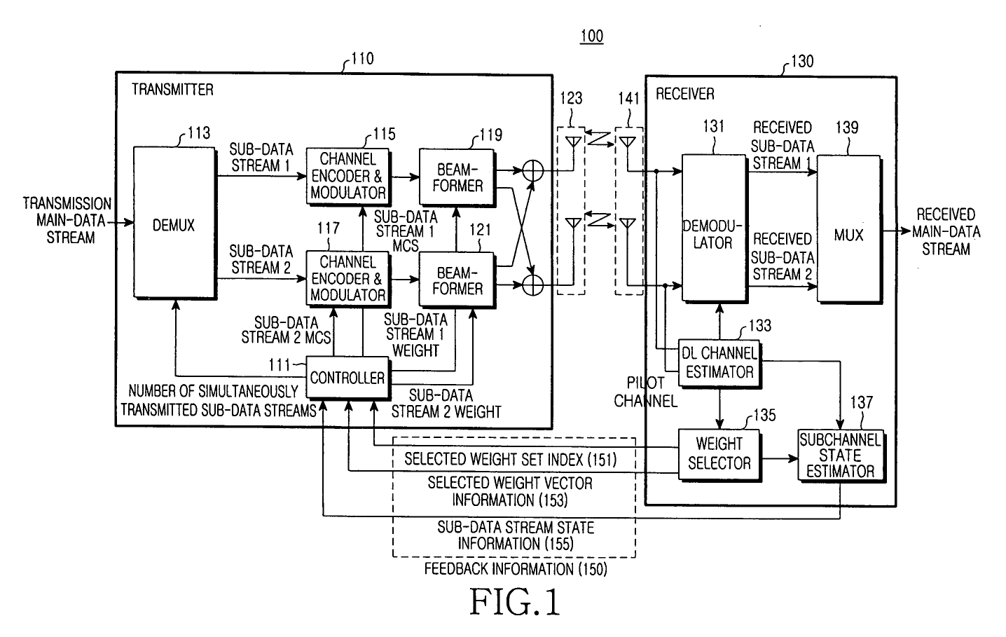

FIG. 1 illustrates architecture of a system according to an embodiment of the present invention. In this exemplary embodiment, the number of antennas is 2 both in the transmitter and the receiver.

Referring to FIG. 1, in a system 100 of the present invention, a receiver 130 includes a downlink channel estimator 133, a demodulator 131, a weight selector 135, a sub-channel state estimator 137, and a multiplexer 139, and a transmitter 110 includes a controller 111, a demultiplexer 113, channel encoders/modulators 115 and 117, and beamformers 119 and 121.

The downlink channel estimator 133 estimates a pilot channel of a received signal transmitted from the transmitter 110, and transmits the estimated information to the weight selector 135. The weight selector 135 generates a weight set configured according to the number of antennas and a weight vector in each weight set based on the estimated information, and transmits the generated weight set index 151 and weight vector information 153 to the transmitter 110, as well as to the sub-channel state estimator 137. The sub-channel state estimator 137 estimates a state of each sub-data stream (hereinafter, “sub-data stream state”) for the weight set selected according to the information transferred from the weight selector 135, and transmits the sub-data stream state information to the transmitter 110.

The controller 111 of the transmitter 110 receives feedback information 150 transmitted from the receiver 130. The controller 111 controls the demultiplexer 113, the channel encoders/modulators 115 and 117, and the beamformers 119 and 121 using the feedback information 150. Specifically, the controller 111 determines the number of final sub-data streams using the feedback information 150, and provides the corresponding information to the demultiplexer 113. Further, the controller 111 determines a coding rate and modulation scheme of each sub-data stream based on the sub-data stream's channel state information 155 in the feedback information 150, and provides the corresponding information to the channel encoders/modulators 115 and 117. In addition, the controller 111 calculates a weight to be applied to each sub-data stream during beamforming, using the weight set index 151 or the weight vector information 153 selected in the corresponding weight set in the feedback information 150, and provides the corresponding information to the beamformers 119 and 121.

The demultiplexer 113 demultiplexes the main-data stream according to the number of sub-data streams transferred from the controller 111. The channel encoders/modulators 115 and 117 encode/modulate the demultiplexed sub-data streams independently, using the coding rate and modulation scheme received from the controller 111. The beamformers 119 and 121 multiply sub-data streams transferred from the channel encoders/modulators 115 and 117 by predetermined weights. Then, the transmitter 110 sums up the sub-data streams and transmits the data via the transmit antennas 123.

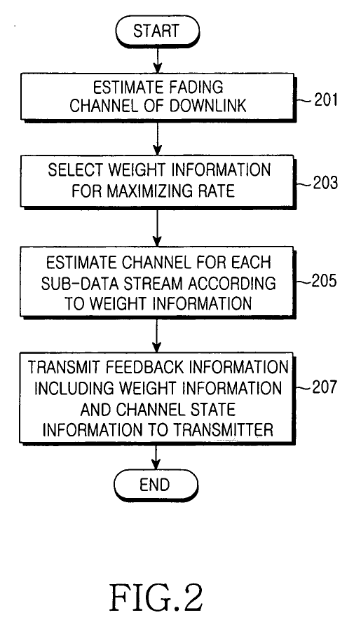

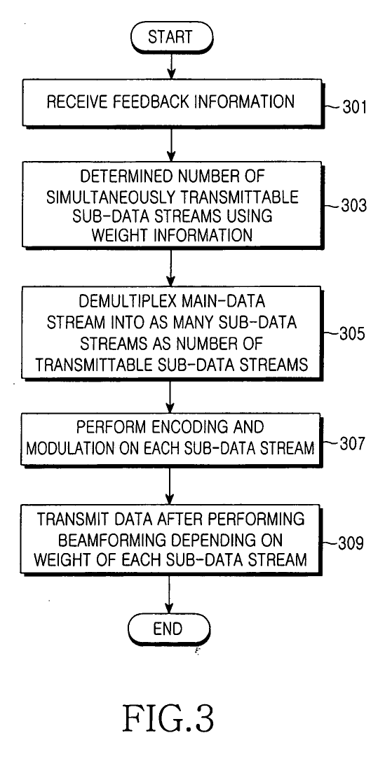

With reference to FIGS. 2 and 3, a data transmission method of a transmitter/receiver in a system according to an embodiment of the present invention will now be described.

FIG. 2 illustrates a data transmission/reception method performed in a receiver 130 of the system of FIG. 1.

Referring to FIG. 2, a downlink channel estimator 133 of the receiver 130 estimates, in step 201, a fading channel of the downlink using a pilot channel or pilot symbol received from multiple receive antennas 141. That is, the downlink channel estimator 133 estimates a fading channel for the downlink from each transmit antenna to each receive antenna. Thereafter, in step 203, the weight selector 135 selects weight information for maximizing the data rate based on the estimated fading channel information. “Weight information” as used herein refers to the weight set index 151 and the weight vector information 153.

In the detailed description of step 203, for N weight sets, the weight selector 135 selects weight vectors for maximizing the data rate from among each weight set, and calculates an available data rate depending on the selected weight vectors. That is, the weight selector 135 compares available data rates for the selected N weight sets (each having, as its elements, weight vectors selected in the corresponding weight set), and determines a weight set having the maximum data rate depending on the comparison result. The weight selector 135 determines an index of the weight set to which the weight set having the maximum rate belongs, and determines the weight vectors belonging to the weight set having the maximum rate, as the weights to be used for actual transmission.

In step 205, the sub-channel state estimator 137 estimates a channel of each sub-data stream according to the weight information. That is, the sub-channel state estimator 137 calculates Signal-to-Interference plus Noise Ratios (SINRs) of the sub-data streams formed by the weights selected by the weight selector 135, and determines sub-data stream's channel state information or Modulation and Coding Selection (MCS). Thereafter, in step 207, the receiver 130 transmits feedback information 150 including the weight information and channel state information to the transmitter 110. Here, the receiver 130 can transmit the channel state information along with the weight information, or can transmit the channel state information using another channel.

FIG. 3 illustrates a data transmission/reception method performed in a transmitter 110 of the system of FIG. 1.

Referring to FIG. 3, a controller 111 of the transmitter 110 receives feedback information 150 from the receiver 130 in step 301. Thereafter, in step 303, the controller 111 determines the number of transmittable sub-data streams using weight information in the feedback information 150. Here, the number of transmittable sub-data streams is equal to the number of selected weights.

In step 305, the demultiplexer 113 demultiplexes the desired transmission main-data stream into as many sub-data streams as the number of transmittable sub-data streams. In step 307, the channel encoders/modulators 115 and 117 each encode the sub-data streams independently according to the coding rate and modulation scheme determined from the feedback sub-data stream's channel state information, and map them to corresponding symbols according to the modulation scheme. Thereafter, in step 309, the beamformers 119 and 121 multiply the sub-data streams by the weight provided from the controller 111, and transmit the resulting sub-data streams to the transmit antenna 123.

In the process of determining a weight set and weight vectors in the set according to the embodiment of the present invention, in order to feed back a precoder composed of weights for maximizing the data rate to the transmitter 110, there is a need for a feedback channel used for transferring a selected weight set index 151 and weight vector information 153 for the weights selected in the selected weight set. If N weight sets are designed by Equation (1) and the N weight sets are agreed upon between a transmitter and receivers in the cell, the number of bits allocated to a feedback channel for feeding back an index 153 of the selected weight set is └ log₂ N┘ bits, where └x┘ denotes the minimum integer which is greater than or equal to ‘x’.

To indicate the weights selected in one weight set, when a scheme of indicating weight-based selection/non-selection is used for the weights belonging to the selected weight set, there is a need for 1-bit feedback information for each weight. Therefore, the scheme needs as many feedback bits as the total number of transmit antennas, and the amount of feedback information needed for feeding back the precoder is a total of └ log₂ N┘+n_{T} bits/use. In addition, a feedback channel for feeding back the sub-data stream's channel state information, formed by the weights estimated and selected by the sub-channel state estimator 137 is required.

Next, a method for designing a weight set according to the present invention will be described.

2) Weight Set Design for Knockdown Precoding Technology

The transmitter 110 and the receiver 130 predetermine and predefine a plurality of weight sets. The weight set is a set having, as its elements, as many weight vectors as the number n_{T} of transmit antennas. For short, the weight vector may be called ‘weight’. Herein, one weight vector is composed of n_{T} complex elements. Therefore, when N weight sets are defined, a total of N×n_{T} weight vectors can be designed.

The following two principles are given to consider a spatial correlation in designing N weight sets.

First, n_{T} weights belonging to one weight set are orthonormal (or orthogonal) with each other, and a size of each weight is 1.

Second, the main beam directions of the beams formed by a total of N×n_{T} weight vectors should not overlap each other, and should be uniformly distributed in the service area.

To determine a total of N weight sets satisfying the first and second principles, a total of N′n_{T} weight vectors where a phase difference between neighbor elements of each weight vector is a multiple of

$$\frac{2 π}{N \cdot {n}_{T}}$$

are generated, and n_{T} weights where a phase difference between elements having the same positions in weight vectors among the generated weight vectors is a multiple of

$$\frac{2 π}{{n}_{T}}$$

are grouped into one weight set, thereby determining a total of N weight sets in which n_{T} weights belonging to the same weight set are orthonormal with each other.

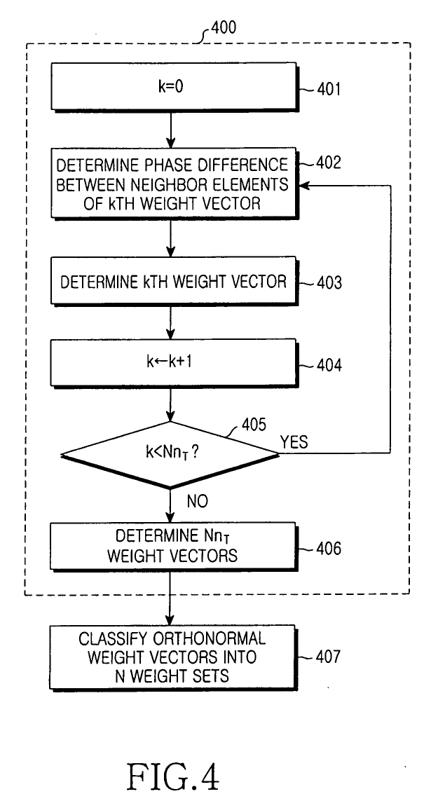

FIG. 4 illustrates an exemplary process of determining a total of N weight sets as described above.

Referring to FIG. 4, step 400 indicates a process of generating N×n_{T} weight vectors. First, a receiver receives N weight sets and the number n_{T} of transmit antennas. To find N×n_{T} weight vectors, the receiver undergoes a cyclic process of step 401 to 405 for k=0 to k=N×n_{T}. In step 402, the receiver calculates a phase difference

$${Δ}_{k} = \frac{2 π k}{{Nn}_{T}}$$

between neighbor elements in a weight vector for finding a k^{th} weight vector. Using the calculated phase difference, the receiver determines a k^{th} weight vector in step 403. A first element of the k^{th} weight vector is always

$$\frac{1}{\sqrt{{n}_{T}}} ,$$

and a second element thereof is

$$\frac{1}{\sqrt{{n}_{T}}} exp ( {jΔ}_{k} )$$

having Δₖ as a phase, i.e., is

$$\frac{1}{\sqrt{{n}_{T}}} exp ( j \frac{2 π k}{{Nn}_{T}} ) .$$

A third element is

$$\frac{1}{\sqrt{{n}_{T}}} exp ( {j2Δ}_{k} )$$

in which the phase is increased by Δₖ from the second element. i.e., is

$$\frac{1}{\sqrt{{n}_{T}}} exp ( j \frac{4 π k}{{Nn}_{T}} ) .$$

If n_{T} elements are all filled in this manner, the k^{th} weight vector is completed. After determining the k^{th} weight vector, the receiver increases k by one in step 404, and determines a (k+1)^{th} weight vector by repeating steps 402 and 403. The receiver determines all of N×n_{T} weight vectors in step 406. Thereafter, in step 407, the receiver gathers only the orthonormal weight vectors among the determined weight vectors, and classifies them into weight sets. A classification criterion is to gather, into one weight set, n_{T} weights where a phase difference between elements having the same positions in weight vectors among the determined weight vectors is a multiple of

$$\frac{2 π}{{n}_{T}} .$$

If the weight sets are classified to satisfy this criterion, a weight set 1 is composed of k^{th}=0, N, 2N, . . . , (n_{T}−1)N weight vectors, and a weight set 2 is composed of k^{th}=1, N+1, 2N+1, . . . , (n_{T}−1)N+1 weight vectors. For generalization, a weight set n+1 is composed of k^{th}=1, N+n, 2N+n, . . . , (n_{T}−1)N+n weight vectors.

The detailed exemplary design of the foregoing weight set design principle can be mathematically expressed as follows. When N weight sets {Eₙ}_{n=1,L,N} are designed, each weight set Eₙ is a set having, as its elements, n_{T} orthonormal weight vectors {e_{n,i}}_{i=1,L,n}_{_{T}}. That is, Eₙ={e_{n,1},e_{n,2},L, e_{n,n}_{_{T}}}. Here, e_{n,i} denotes an i^{th} weight vector belonging to an n^{th} weight set Eₙ, and is designed as shown in Equation (1).

$${e}_{n , i} = \frac{1}{\sqrt{{n}_{T}}} [ \begin{matrix}{ω}_{1 , i}^{( n )} \\ ⋮ \\ {ω}_{{n}_{T} , i}^{( n )}\end{matrix} ] = \frac{1}{\sqrt{{n}_{T}}} [ \begin{matrix}1 \\ {e}^{j \frac{2 π}{{n}_{T}} ( \frac{n - 1}{N} + ( i - 1 ) )} \\ {e}^{j2 \frac{2 π}{{n}_{T}} ( \frac{n - 1}{N} + ( i - 1 ) )} \\ ⋮ \\ {e}^{j ( {n}_{T} - 1 ) \frac{2 π}{{n}_{T}} ( \frac{n - 1}{N} + ( i - 1 ) )}\end{matrix} ] \qquad ( 1 )$$

In Equation (1), ω_{m,i}⁽ⁿ⁾, is defined as Equation (2).

$${ω}_{m , i}^{( n )} = exp \{ j ( m - 1 ) {φ}_{n , i} \} = exp \{ j \frac{2 π ( m - 1 )}{{n}_{T}} ( \frac{n - 1}{N} + i - 1 ) \} \qquad ( 2 )$$

In Equation (2),

$${φ}_{n , i} = \frac{2 π}{{n}_{T}} ( \frac{n - 1}{N} + i - 1 )$$

indicates a reference phase of an i^{th} weight vector belonging to an n^{th} weight set Eₙ.

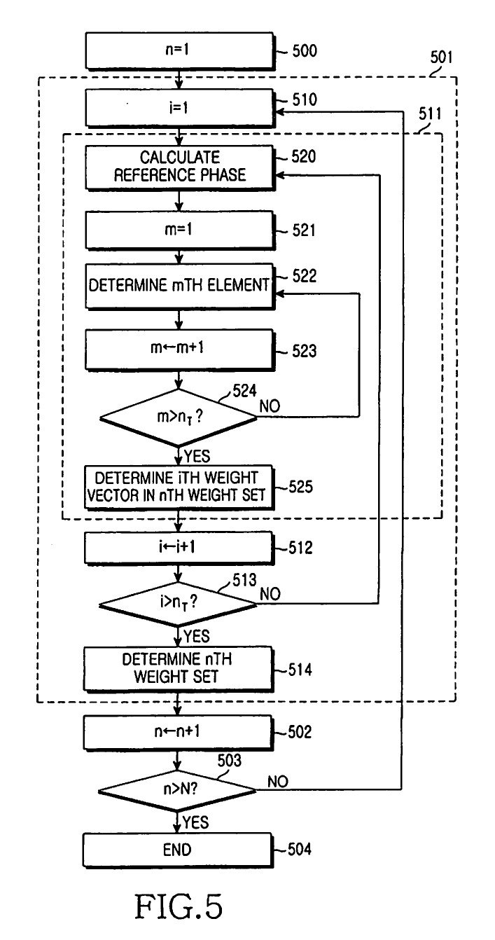

FIG. 5 illustrates another exemplary process of determining a weight set according to the present invention. The shown process determines a total of N weight sets according to Equation (1).

In step 500, a receiver initializes a weight set index n to 1. Because the receiver calculates an n^{th} weight set in step 501, the receiver calculates a first weight set immediately after step 500. In step 502, the receiver increases n one-by-one to repeat step 501 until a total of N weight sets are completed. If all weight sets are completed, the receiver ends the process in step 504.

Step 501 includes a process of calculating n_{T} weight vectors in an n^{th} weight set. In step 510, the receiver initializes a weight vector index i to 1 for an n^{th} weight set. In step 511, the receiver determines an i^{th} weight vector in the n^{th} weight set. That is, immediately after step 510, the receiver calculates a first weight vector in the n^{th} weight set. In step 512, the receiver increases i one-by-one to repeat step 511 until a total of n_{T} weight vectors in the n^{th} weight set are completed. If all weight vectors in the n^{th} weight set are determined, the receiver completes the determination of the n^{th} weight set in step 514, and then undergoes the next weight set determination process.

Step 511 includes a process of calculating an i^{th} weight vector in the n h weight set. In step 520, the receiver determines a reference phase φ_{n,i} for calculating the i^{th} weight vector in the n^{th} weight set. After determining the reference phase, the receiver calculates each element of the i^{th} weight vector in the n^{th} weight set, using the determined reference phase. In step 521, the receiver first initializes element index m to 1. In step 522, the receiver determines an m^{th} element of the i^{th} weight vector in the n^{th} weight set by applying the reference phase φ_{n,i} calculated in step 520 to ω_{m,i}⁽ⁿ⁾=exp{j(m−1) φ_{n,i}}. That is, immediately after step 521, the receiver calculates a first element of the i^{th} weight vector in the n^{th} weight set. By repeating this process for m=1 to m=n_{T}, the receiver completes the i^{th} weight vector in the n^{th} weight set in step 525, and then undergoes a process of determining the next weight vector.

In the MIMO antenna system with 4 transmit antennas, 2 weight sets can be designed as given in Equation (3).

$${ɛ}_{1} = \{ {e}_{1 , 1} , {e}_{1 , 2} , {e}_{1 , 3} , {e}_{1 , 4} \} = \{ \frac{1}{2} [ \begin{matrix}1 \\ 1 \\ 1 \\ 1\end{matrix} ] , \frac{1}{2} [ \begin{matrix}1 \\ {e}^{jπ / 2} \\ {e}^{jπ} \\ {e}^{j3π / 2}\end{matrix} ] , \frac{1}{2} [ \begin{matrix}1 \\ {e}^{jπ} \\ {e}^{j 2 π} \\ {e}^{j3π}\end{matrix} ] , \frac{1}{2} [ \begin{matrix}1 \\ {e}^{j3π / 2} \\ {e}^{jπ} \\ {e}^{j9π / 2}\end{matrix} ] \} \\ {ɛ}_{2} = \{ {e}_{2 , 1} , {e}_{2 , 2} , {e}_{2 , 3} , {e}_{2 , 4} \} = \{ \frac{1}{2} [ \begin{matrix}1 \\ {e}^{jπ / 4} \\ {e}^{jπ / 2} \\ {e}^{j3π / 4}\end{matrix} ] , \frac{1}{2} [ \begin{matrix}1 \\ {e}^{j3π / 4} \\ {e}^{j3π / 2} \\ {e}^{j9π / 4}\end{matrix} ] , \frac{1}{2} [ \begin{matrix}1 \\ {e}^{j5π / 4} \\ {e}^{j 5 π / 2} \\ {e}^{j15π / 4}\end{matrix} ] , \frac{1}{2} [ \begin{matrix}1 \\ {e}^{j7π / 4} \\ {e}^{j7π / 2} \\ {e}^{j21π / 4}\end{matrix} ] \} \qquad ( 3 )$$

Four weights belonging to E₁ of Equation (3) are orthonormal with each other, and with a size of 1. Similarly, four weights belonging to E₂ are also orthonormal with each other, and a size thereof is 1. However, the weights {e_{1,i}}_{i=1,2,3,4} and {e_{2,i}}_{i=1,2,3,4} belonging to other weight sets are not orthonormal with each other. When data streams are transmitted by orthonormal weights, interference between the simultaneously transmitted data streams is minimized, thus maximizing the rate sum by the simultaneously transmitted data streams.

The Knockdown Precoding technology of the present invention designs the weight sets such that weights belonging to one weight set are orthonormal with each other, and allows the simultaneously transmitted data streams to be transmitted by the weights selected in one weight set, thereby reducing the interference between the simultaneously transmitted data streams and thus maximizing the rate sum by the simultaneously transmitted data streams. In addition, the directions of the main beams (or main lobes) formed by the 8 weights belonging to E₁ and E₂ do not overlap each other, and are uniformly distributed in the service area. This makes it possible to obtain beamforming gain caused by one or multiple weights among the 8 transmission weights regardless of which direction the receivers randomly distributed in the service area of the transmitter are located.

If the receiver selects the weights such that the rate sum by the simultaneously transmitted sub-data streams among a total of N×n_{T} weights is maximized, there is a high probability that the selected weights will belong to the same weight set. Therefore, with the use of a hierarchical expression scheme of selecting one weight set and expressing the weights selected in the corresponding weight set, the receiver can minimize the amount of feedback information for expressing the selected weights for maximizing the data rate.

The exemplary cases satisfying Equation (1) for the number n_{T} of transmit antennas and the number N of weight sets in the system according to the present invention are shown in Table 1 to Table 12. In the following tables, (x,y) denotes a complex number having a real component x and an imaginary component y. That is, (x,y)=x+yi.

TABLE 1
(for n_{T} = 2 and N = 1)

| Set | Weight 1 | Weight 2 |
|---|---|---|
| 1 | (0.7071, 0.0000) | (0.7071, 0.0000) |
| | (0.7071, 0.0000) | (−0.7071, 0.0000) |

TABLE 2
(for n_{T} = 2 and N = 2)

| Set | Weight 1 | Weight 2 |
|---|---|---|
| 1 | (0.7071, 0.0000) | (0.7071, 0.0000) |
| | (0.7071, 0.0000) | (−0.7071, 0.0000) |
| 2 | (0.7071, 0.0000) | (0.7071, 0.0000) |
| | (0.0000, 0.7071) | (0.0000, −0.7071) |

TABLE 3
(for n_{T} = 2 and N = 3)

| Set | Weight 1 | Weight 2 |
|---|---|---|
| 1 | (0.7071, 0.0000) | (0.7071, 0.0000) |
| | (0.7071, 0.0000) | (−0.7071, 0.0000) |
| 2 | (0.7071, 0.0000) | (0.7071, 0.0000) |
| | (0.3536, 0.6124) | (−0.3536, −0.6124) |
| 3 | (0.7071, 0.0000) | (0.7071, 0.0000) |
| | (−0.3536, −0.6124) | (0.3536, −0.6124) |

TABLE 4
(for n_{T} = 2 and N = 4)

| Set | Weight 1 | Weight 2 |
|---|---|---|
| 1 | (0.7071, 0.0000) | (0.7071, 0.0000) |
| | (0.7071, 0.0000) | (−0.7071, 0.0000) |
| 2 | (0.7071, 0.0000) | (0.7071, 0.0000) |
| | (0.5000, 0.5000) | (−0.5000, −0.5000) |
| 3 | (0.7071, 0.0000) | (0.7071, 0.0000) |
| | (0.0000, 0.7071) | (0.0000, −0.7071) |
| 4 | (0.7071, 0.0000) | (0.7071, 0.0000) |
| | (−0.5000, 0.5000) | (0.5000, −0.5000) |

TABLE 5
(for n_{T} = 3 and N = 1)

| Set | Weight 1 | Weight2 | Weight 3 |
|---|---|---|---|
| 1 | (0.5774, 0.0000) | (0.5774, 0.0000) | (0.5774, 0.0000) |
| | (0.5774, 0.0000) | (−0.2887, 0.5000) | (−0.2887, −0.5000) |
| | (0.5774, 0.0000) | (−0.2887, −0.5000) | (−0.2887, 0.5000) |

TABLE 6
(for n_{T} = 3 and N = 2)

| Set | Weight 1 | Weight2 | Weight 3 |
|---|---|---|---|
| 1 | (0.5774, 0.0000) | (0.5774, 0.0000) | (0.5774, 0.0000) |
| | (0.5774, 0.0000) | (−0.2887, 0.5000) | (−0.2887, −0.5000) |
| | (0.5774, 0.0000) | (−0.2887, −0.5000) | (−0.2887, 0.5000) |
| 2 | (0.5774, 0.0000) | (0.5774, 0.0000) | (0.5774, 0.0000) |
| | (0.2887, 0.5000) | (−0.5774, 0.0000) | (0.2887, −0.5000) |
| | (−0.2887, 0.5000) | (0.5774, 0.0000) | (−0.2887, −0.5000) |

TABLE 7
(for n_{T} = 3 and N = 3)

| Set | Weight 1 | Weight2 | Weight 3 |
|---|---|---|---|
| 1 | (0.5774, 0.0000) | (0.5774, 0.0000) | (0.5774, 0.0000) |
| | (0.5774, 0.0000) | (−0.2887, 0.5000) | (−0.2887, −0.5000) |
| | (0.5774, 0.0000) | (−0.2887, −0.5000) | (−0.2887, 0.5000) |
| 2 | (0.5774, 0.0000) | (0.5774, 0.0000) | (0.5774, 0.0000) |
| | (0.4423, 0.3711) | (0.1003, −0.5686) | (0.1003, −0.5686) |
| | (0.1003, 0.5686) | (−0.5425, −0.1975) | (−0.5425, −0.1975) |
| 3 | (0.5774, 0.0000) | (0.5774, 0.0000) | (0.5774, 0.0000) |
| | (0.1003, 0.5686) | (−0.5425, −0.1975) | (0.4423, −0.3711) |
| | (−0.5425, 0.1975) | (0.4423, 0.3711) | (0.1003, −0.5686) |

TABLE 8
(for n_{T} = 3 and N = 4)

| Set | Weight 1 | Weight2 | Weight 3 |
|---|---|---|---|
| 1 | (0.5774, 0.0000) | (0.5774, 0.0000) | (0.5774, 0.0000) |
| | (0.5774, 0.0000) | (−0.2887, 0.5000) | (−0.2887, −0.5000) |
| | (0.5774, 0.0000) | (−0.2887, −0.5000) | (−0.2887, 0.5000) |
| 2 | (0.5774, 0.0000) | (0.5774, 0.0000) | (0.5774, 0.0000) |
| | (0.5000, −0.2887) | (−0.5000, 0.2887) | (0.0000, −0.5774) |
| | (0.2887, 0.5000) | (0.2887, −0.5000) | (−0.5774, 0.0000) |
| 3 | (0.5774, 0.0000) | (0.5774, 0.0000) | (0.5774, 0.0000) |
| | (0.2887, 0.5000) | (−0.5774, 0.0000) | (0.2887, −0.5000) |
| | (−0.2887, 0.5000) | (0.5774, 0.0000) | (−0.2887, −0.5000) |
| 4 | (0.5774, 0.0000) | (0.5774, 0.0000) | (0.5774, 0.0000) |
| | (0.0000, 0.5774) | (−0.5000, −0.2887) | (0.5000, −0.2887) |
| | (−0.5774, 0.0000) | (0.2887, 0.5000) | (0.2887, −0.5000) |

TABLE 9
(for n_{T} = 4 and N = 1)

| Set | Weight 1 | Weight2 | Weight 3 | Weight 4 |
|---|---|---|---|---|
| 1 | (0.5000, 0.0000) | (0.5000, 0.0000) | (0.5000, 0.0000) | (0.5000, 0.0000) |
| | (0.5000, 0.0000) | (0.0000, 0.5000) | (−0.5000, 0.0000) | (0.0000, −0.5000) |
| | (0.5000, 0.0000) | (−0.5000, 0.0000) | (0.5000, 0.0000) | (−0.5000, 0.0000) |
| | (0.5000, 0.0000) | (0.0000, −0.5000) | (−0.5000, 0.0000) | (0.0000, 0.5000) |

TABLE 10
(for n_{T} = 4 and N = 2)

| Set | Weight 1 | Weight2 | Weight 3 | Weight 4 |
|---|---|---|---|---|
| 1 | (0.5000, 0.0000) | (0.5000, 0.0000) | (0.5000, 0.0000) | (0.5000, 0.0000) |
| | (0.5000, 0.0000) | (0.0000, 0.5000) | (−0.5000, 0.0000) | (0.0000, −0.5000) |
| | (0.5000, 0.0000) | (−0.5000, 0.0000) | (0.5000, 0.0000) | (−0.5000, 0.0000) |
| | (0.5000, 0.0000) | (0.0000, −0.5000) | (−0.5000, 0.0000) | (0.0000, 0.5000) |
| 2 | (0.5000, 0.0000) | (0.5000, 0.0000) | (0.5000, 0.0000) | (0.5000, 0.0000) |
| | (0.3536, 0.3536) | (−0.3536, 0.3536) | (−0.3536, −0.3536) | (0.3536, −0.3536) |
| | (0.0000, 0.5000) | (0.0000, −0.5000) | (0.0000, 0.5000) | (0.0000, −0.5000) |
| | (−0.3536, 0.3536) | (0.3536, 0.3536) | (0.3536, −0.3536) | (−0.3536, −0.3536) |

TABLE 11
(for n_{T} = 4 and N = 3)

| Set | Weight 1 | Weight2 | Weight 3 | Weight 4 |
|---|---|---|---|---|
| 1 | (0.5000, 0.0000) | (0.5000, 0.0000) | (0.5000, 0.0000) | (0.5000, 0.0000) |
| | (0.5000, 0.0000) | (0.0000, 0.5000) | (−0.5000, 0.0000) | (0.0000, −0.5000) |
| | (0.5000, 0.0000) | (−0.5000, 0.0000) | (0.5000, 0.0000) | (−0.5000, 0.0000) |
| | (0.5000, 0.0000) | (0.0000, −0.5000) | (−0.5000, 0.0000) | (0.0000, 0.5000) |
| 2 | (0.5000, 0.0000) | (0.5000, 0.0000) | (0.5000, 0.0000) | (0.5000, 0.0000) |
| | (0.4330, 0.2500) | (−0.2500, 0.4330) | (−0.4330, −0.2500) | (0.2500, −0.4330) |
| | (0.2500, 0.4330) | (−0.2500, −0.4330) | (0.2500, 0.4330) | (−0.2500, −0.4330) |
| | (0.0000, 0.5000) | (0.5000, 0.0000) | (0.0000, −0.5000) | (−0.5000, 0.0000) |
| 3 | (0.5000, 0.0000) | (0.5000, 0.0000) | (0.5000, 0.0000) | (0.5000, 0.0000) |
| | (0.2500, 0.4330) | (−0.4330, 0.2500) | (−0.2500, −0.4330) | (0.4330, −0.2500) |
| | (−0.2500, 0.4330) | (0.2500, −0.4330) | (−0.2500, 0.4330) | (0.2500, −0.4330) |
| | (−0.5000, 0.0000) | (0.0000, 0.5000) | (0.5000, 0.0000) | (0.0000, −0.5000) |

TABLE 12
(for n_{T} = 4 and N = 4)

| Set | Weight 1 | Weight2 | Weight 3 | Weight 4 |
|---|---|---|---|---|
| 1 | (0.5000, 0.0000) | (0.5000, 0.0000) | (0.5000, 0.0000) | (0.5000, 0.0000) |
| | (0.5000, 0.0000) | (0.0000, 0.5000) | (−0.5000, 0.0000) | (0.0000, −0.5000) |
| | (0.5000, 0.0000) | (−0.5000, 0.0000) | (0.5000, 0.0000) | (−0.5000, 0.0000) |
| | (0.5000, 0.0000) | (0.0000, −0.5000) | (−0.5000, 0.0000) | (0.0000, 0.5000) |
| 2 | (0.5000, 0.0000) | (0.5000, 0.0000) | (0.5000, 0.0000) | (0.5000, 0.0000) |
| | (0.4619, 0.1913) | (−0.1913, 0.4619) | (−0.4619, −0.1913) | (0.1913, −0.4619) |
| | (0.3536, 0.3536) | (−0.3536, −0.3536) | (0.3536, 0.3536) | (−0.3536, −0.3536) |
| | (0.1913, 0.4619) | (0.4619, −0.1913) | (−0.1913, −0.4619) | (−0.4619, 0.1913) |
| 3 | (0.5000, 0.0000) | (0.5000, 0.0000) | (0.5000, 0.0000) | (0.5000, 0.0000) |
| | (0.3536, 0.3536) | (−0.3536, 0.3536) | (−0.3536, −0.3536) | (0.3536, −0.3536) |
| | (0.0000, 0.5000) | (0.0000, −0.5000) | (0.0000, 0.5000) | (0.0000, −0.5000) |
| | (−0.3536, 0.3536) | (0.3536, 0.3536) | (0.3536, −0.3536) | (−0.3536, −0.3536) |
| 4 | (0.5000, 0.0000) | (0.5000, 0.0000) | (0.5000, 0.0000) | (0.5000, 0.0000) |
| | (0.1913, 0.4619) | (−0.4619, 0.1913) | (−0.1913, −0.4619) | (0.4619, −0.1913) |
| | (−0.3536, 0.3536) | (0.3536, −0.3536) | (−0.3536, 0.3536) | (0.3536, −0.3536) |
| | (−0.4619, −0.1913) | (−0.1913, 0.4619) | (0.4619, 0.1913) | (0.1913, −0.4619) |

3) Structure and Operation Method of Feedback Channel for Knockdown Precoding Technology

In FIG. 1, the feedback information 150 for supporting the Knockdown Precoding technology is defined as the selected weight set index 151, the selected weight vector information 153 and the sub-data stream state information 155. The actually needed amount of sub-data stream state information 155 depends on the number of selected weight vectors, i.e., the number of actually transmitted sub-data streams. For example, if only one weight vector is selected, one sub-data stream will be transmitted, so the feedback sub-data stream state information is state information of one transmission sub-data stream. As another example, if two weight vectors are selected, state information of the two sub-data streams should be subject to feedback. To effectively reduce a load of the feedback channel, there is a need for a function capable of adaptively adjusting the amount of resources consumed for feeding back sub-data stream state information according to the number of selected weight vectors.

Channel Quality Information (CQI), or channel state, of a sub-data stream transmission channel formed with a k^{th} weight vector in one weight set will be denoted herein by cqi[k]. If a weight vector is not selected, the CQI corresponding to this weight vector is set as NULL. The receiver rearranges (or reorders) the sub-data stream state information cqi[k] such that the CQI set as NULL is placed in the rear. For example, suppose that the number n_{T} of transmit antennas of the transmitter is 4, the second and third weight vectors are selected and the first and fourth weight vector are unselected. Then cqi[1] and cqi[4] will be set as NULL, and cqi[2] and cqi[3] will be set as valid values. The CQIs, after undergoing the rearrangement process, can be expressed as CQI(m) such that CQI(1)=cqi[2], CQI(2)=cqi[3], CQI(3)=NULL (4)=NULL.

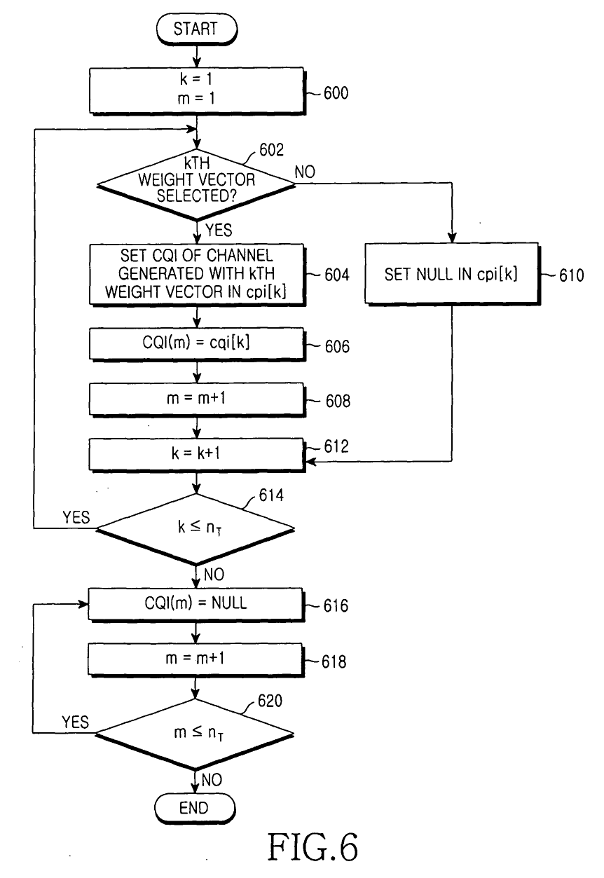

FIG. 6 illustrates a process, of rearranging CQIs according to the weight vectors selected in above-described manner.

Referring to FIG. 6, in step 600, a receiver initializes both k for defining orders of weight vectors and m for defining orders of rearranged CQIs to ‘1’. In step 602, the receiver determines if a k^{th} weight vector is selected. If it is determined in step 602 that the k^{th} weight vector is selected, the receiver fills a value of cqi[k] in step 604. Thereafter, the receiver fills CQI(m) with the cqi[k] value in step 606, and increases m by one in step 608. However, if it is determined in step 602 that the k^{th} weight vector is unselected, the receiver fills cqi[k] with NULL in step 610.

The receiver increases k one-by-one, in step 612, and determines in step 614 whether k is not greater than the number n_{T} of transmit antennas. If it is determined in step 614 that k is less than or equal to n_{T}, the receiver returns to step 602 and repeats steps 602 to 612. However, if it is determined in step 614 that k is greater than n_{T}, the receiver fills CQI(m) with NULL in step 616, and increases m by one in step 618. Thereafter, the receiver determines in step 620 whether m is less than or equal to n_{T}. If it is determined in step 620 that m is not greater than n_{T}, the receiver repeats steps 616 to 618 to fill all the remaining CQIs with NULL. However, if m is greater than n_{T}, the receiver ends the process.

Although the process of FIG. 6 shows an algorithm of filling both of cqi[k] and CQI(m), the process of inputting cqi[k] can be omitted because the actual transmission is achieved only with CQI(m). Through this process, the receiver sets CQI(1) through CQI(n_{T}) as valid values, and inserts NULL in the other CQIs.

The sub-data stream state information with CQI=NULL does not need to undergo feedback. The embodiment of the present invention provides a method for reducing a load caused by the feedback of CQI=NULL when the feedback channel is for a Code Division Multiple Access (CDMA) system. For example, suppose that the feedback channel is composed of a weight feedback channel for transmitting a weight set index, and a channel state feedback channel for transmitting sub-data stream state information for a weight vector included in the weight set with the weight set index. The transmitter 110, if it receives only the weight feedback channel, can determine how many weight vectors will be actually used for the transmission, so it can detect the amount of sub-data stream state information. That is, as to the CQI information which is set as NULL due to the unused weight vector, the transmitter 110 can already detect the CQI information only with the receipt of the weight feedback channel. Therefore, the transmitter 110 does not need to perform the process of receiving CQI=NULL feedback information. In the CDMA system, the entire system capacity depends upon the interference. That is, a reduction in the unnecessary interference can contribute to an increase in the capacity.

To reduce the interference, the more-than-necessary power should not be used for transmission. Because the CQI=NULL feedback information is not the reception-intended information, it is possible to reduce transmission power of the channel state feedback channel including NULL. For example, if only the CQI(1) is set as a valid value and the remaining CQIs are set as NULL, the transmitter 110 can enable showing of the same feedback information reception performance even though it uses lower transmission power as compared with the case where all CQIs are set as valid values. This is because it is possible to reduce the detection threshold based on the fact that NULL has already been set in the process of receiving the feedback channel. The reduction in the detection threshold means the availability of receiving the feedback signal with the lower power. Therefore, the receiver can transmit the feedback signal with the higher power if the number of the selected weight vectors is greater than a reference, and can transmit the feedback signal with the higher power if the number of the selected weight vectors is less than the reference. If the users transmit the feedback signals with the lower power, the interference may be reduced, making it possible to more users to transmit the feedback signals with the same wireless resources.

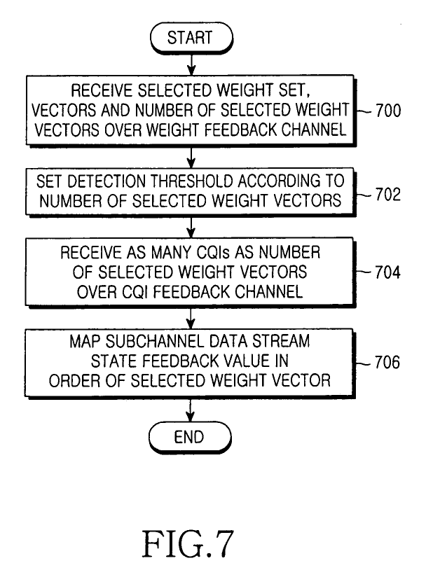

FIG. 7 illustrates a process of receiving, by a transmitter 110, CQIs based on the number of selected weight vectors and mapping the values to the selected weight vectors.

Referring to FIG. 7, in step 700, a transmitter receives selected weight set and vector information transmitted over a weight feedback channel. Based on the received information, the transmitter finds the number of selected weight vectors. In step 702, the transmitter selects a detection threshold according to the number of selected weight vectors. That is, if the number of weight vectors is greater than a reference, the transmitter increases the detection threshold, and if the number of weight vectors is less than the reference, the transmitter decreases the detection threshold. In step 704, the transmitter receives sub-channel data stream state information transmitted over a channel state feedback channel. Herein, the reception-intended sub-channel data stream state information, i.e., the number of CQIs, is equal to the number of selected weight vectors. In the reception step 704, the transmitter uses the detection threshold determined in step 702. Thereafter, in step 706, the transmitter performs a process of mapping the sub-channel data stream state information determined in this way, to the actually selected weight vectors. Step 706 is to restore the CQIs rearranged through the process described in FIG. 6, back to their original state.

For example, suppose that n_{T} is 4, second and third weight vectors are selected, and first and fourth weight vectors are unselected. In this case, because the two weight vectors are selected, the transmitter 110 receives CQI(1) and CQI(2). The transmitter 110, because it knows that the second and third weight vectors are selected, can determined that CQI(1) is a state of the channel composed of the second weight vector and CQI(2) is a state of the channel composed of the third weight vector. To clarify the orders, it is necessary to equally match the orders of the received CQIs to the orders of the selected weight vectors.

In the transmission method where one sub-data stream is transmitted over the virtual beams formed by the selected weight vectors on a distributed basis by mixing the selected weight vectors for each symbol without establishing a channel over which one weight vector transmits one sub-data stream, the sub-data stream state information corresponds to the demodulated and decoded orders of the weight vectors rather than to the weight vectors. For example, suppose that two weight vectors are selected. In this case, two sub-data streams are transmitted over the two virtual beams formed by the two weight vectors. The first demodulated/decoded sub-data stream cannot but undergo interference by other sub-data streams, but the second demodulated/decoded sub-data stream can cancel the interference by the first demodulated/decoded sub-data stream. Therefore, the two sub-data streams undergo different CQIs. In this case, CQI(1) corresponds to the first demodulated/decoded sub-data stream, and CQI(2) corresponds to the second demodulated/decoded sub-data stream.

Although it is assumed in the foregoing description that the channel state information of the actually non-transmitted sub-data stream is set as NULL, the same can be possible even though the channel state information is set as an arbitrary predetermined valid value. This is because the transmitter does not actually attempt to receive the channel state information. For the channel state information of the non-transmitted sub-data stream, regardless of whether the channel state information is set as NULL or a valid value, the channel state information should be set as a value previously agreed upon between the transmitter and the receiver. Otherwise, the transmitter cannot reduce the detection threshold in the process of receiving the channel state information of the transmission sub-data stream.

4) Knockdown Precoder Used in SCW MIMO

Single Code Word (SCW) MIMO refers to a technology of MIMO-transmitting a data stream through one encoding/modulation. In the example of FIG. 1, the channel encoders/modulators 115 and 117 are connected to the beamformers 119 and 121, respectively. Each channel encoder/modulator performs a separate operation depending on the received sub-data stream state information 155. However, in SCW MIMO, because only one channel encoder/modulator is used, the data stream state information is not needed and only the representative state information is needed. SCW MIMO, though it does not perform adaptive encoding/modulation for each beam, performs a function of selecting and transmitting only the preferred beam. Therefore, if column vectors are selected by the Knockdown Precoding scheme, one data stream is transmitted over multiple beams formed by the selected vectors.

The conventional SCW MIMO technology has performed SCW MIMO depending on the rank indicating how many layers it will activate, and the representative channel state information CQI, both of which are received over a feedback channel. However, when the knockdown precoder is used, there is no need to use the feedback channel secured for the rank. Therefore, if this part is previously set as the value defined by the transmitter and the receiver, it is possible to effectively decrease the detection threshold and reduce the transmission power of the feedback signal.

Comparison Between the Technology of the Present Invention and Conventional Technology

A comparison between the conventional Precoder Codebook technique and the Knockdown Precoding technology of the present invention will be made in terms of a scheme of adjusting the number of simultaneously transmitted data streams and the amount of feedback information required therefor.

The conventional Precoder Codebook technique separately defines a precoder codebook depending on the number n_{T} of transmit antennas, the number n_{R} of receive antennas, and the number n_{S} of simultaneously transmitted data streams. If the number of simultaneously transmitted data streams is adjusted according to each transmitter/receiver channel condition in the environment where a transmitter having 4 transmit antennas and receivers having 1, 2, 3 and 4 receive antennas, respectively, are in communication with each other in the same cell, the precoder codebooks that should be considered include a total of 10 precoder codebooks of (n_{T},n_{R},n_{S})=(4,1,1), (4,2,1), (4,2,2), (4,3,1), (4,3,2), (4,3,3), (4,4,1), (4,4,2), (4,4,3), and (4,4,4). The transmitter and the receivers predefine the above 10 precoder codebooks. Each receiver feeds back n_{R} receive antennas and the number n_{S} of transmission data streams to the transmitter so that the transmitter may select a precoder codebook. The receiver, based on the estimated downlink channel information, selects a precoder having the maximum transmission capacity in the precoder codebook suitable for n_{R} receive antennas and n_{S} transmission data streams, and feeds back an index of the selected precoder to the transmitter. The transmitter selects a precoder having the feedback index in the precoder codebook suitable for the feedback n_{R} and n_{S}, and transmits data using the selected precoder.

The required amount of feedback information can be ignored because the feedback for n_{R} sufficient with one-time feedback is tiny. However, the feedback for n_{R}, which instantaneously varies according to the channel conditions, should be transmitted to the transmitter along with the feedback information for the index of the selected precoder. Therefore, assuming that each of the precoder codebooks is composed of 8 precoders, there is a need for feedback information of a total of 5 bits/use, because 2-bit/use feedback information for feeding back n_{S} and 3-bit/use feedback information for feeding back the index of the selected precoder are required.

The optimal precoder codebook is subject to change according to the fading spatial correlation of the channel in use. To date, the conventional Precoder Codebook technique designs the precoder codebook under the assumption that there is no spatial correlation of fading. Therefore, the conventional Precoder Codebook technique may suffer performance degradation in channel environments where there is a spatial correlation of fading. To address this problem, the transmitter should make the existing precoder codebook undergo companding, using a spatial correlation matrix of a downlink channel. To this end, the receiver should estimate a spatial correlation matrix of the downlink channel and then feed back the estimated spatial correlation matrix to the transmitter, so not only the feedback information for feeding back n_{S} and the index of the selected feedback, but also the feedback information for feeding back the spatial correlation matrix of the downlink channel are additionally required.

The Knockdown Precoding technology of the present invention predefines N weight sets each composed of as many orthonormal weights as the number n_{T} of transmit antennas. The receiver selects a maximum of min(n_{T},n_{R}) weights for maximizing the transmission data rate, considering the number n_{R} of receive antennas in use. The receiver feeds back the selected weight set's index and the weights selected through the feedback for weight select information in the corresponding set, to the transmitter. The transmitter transmits multiplexed data streams using the weights selected from the weight set selected based on the feedback information. Even though the number of receive antenna of the receivers and the number of simultaneously transmitted data streams are diversified, because N weight sets composed of a total of N·n_{T} weights are commonly used, the amount of feedback information for the weight set to be agreed upon between the transmitter and the receivers is noticeably small, compared to the amount of feedback information needed in the Precoder Codebook technique. In particular, when the number of transmit antennas exceeds 4, the number of precoder codebooks to be considered increases considerably, causing a remarkable increase in the amount of information on the precoder codebooks to be agreed upon between the transmitter and the receivers. On the contrary, in the Knockdown Precoding technique, even though the number n_{T} of transmit antennas increases, the required number N of weight sets decreases, so the amount of information on the weight set to be agreed upon between the transmitter and the receivers scarcely increases. This is because the performance of the Knockdown Precoding technology depends on the total number N·n_{T} of weights.

The feedback information needed in the Closed-Loop Knockdown Precoding technology that uses a dedicated feedback channel for feeding back weight select information, needs └ log₂ N┘ bits/use for feeding back the selected weight set's index, and n_{T} bits/use for feeding back the weight select information, thus needing a total of └ log₂ N┘+n_{T} bits/use. For n_{T}=4 and N=2, a total of 5 bits/use are needed. The feedback information needed in the Open-Loop Knockdown Precoding technology that uses a dedicated feedback channel for feeding back weight select information, merely needs n_{T} bits/use for feeding back the weight select information. In addition, to reduce the amount of feedback information necessary for weight select information, it is possible to use a scheme for feeding back the weight select information using a feedback channel for transmitting sub-data stream's channel state information.

Therefore, the Knockdown Precoding technology of the present invention can select a feedback scheme for transmitting weight select information according to the uplink channel structure of the applied system, and can adjust the number of weight sets in use according to the uplink channel capacity available in the applied system. In particular, when the uplink channel capacity available in the applied system is very low, the Open-Loop Knockdown Precoding technology can be applied.

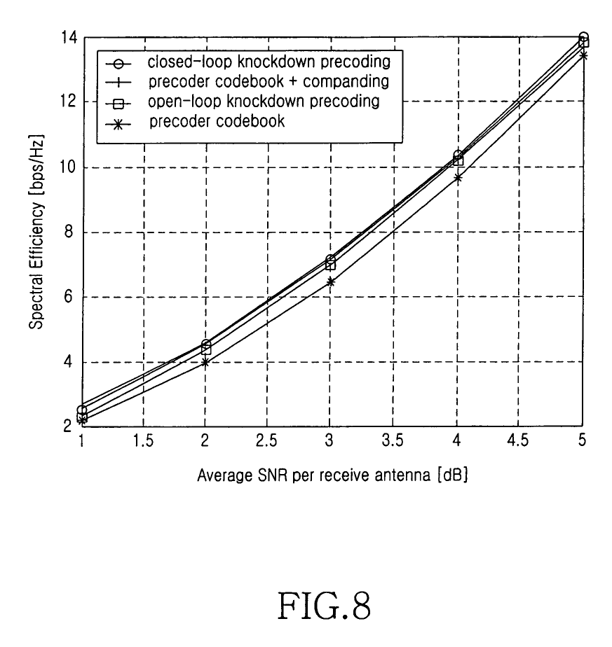

FIG. 8 illustrates a performance comparison result between a Precoder Codebook technique and a Minimum Mean Square Error-Ordered Successive Interference Cancellation (MMSE-OSIC) system to which the Knockdown Precoding technology is applied, in the high-spatial correlation environment, for n_{T}=n_{R}=4. In the Knockdown Precoding technology, when the use of two weight sets is considered, the Closed-Loop Knockdown Precoding technology needs 1 bit for weight set index feedback and 4 bits for feeding back the selection/non-selection of 4 weights, requiring a total of 5-bit/use feedback information. The Open-Loop Knockdown Precoding technology needs 4-bit/use feedback information for feeding back the selection/non-selection of 4 weights. The Precoder Codebook technique needs 2 bits for adjusting the number of simultaneously transmitted data streams and 3 bits for feeding back the selected precoder's index, requiring a total of 5-bit/use feedback information. Making a performance comparison between the Closed-Loop Knockdown Precoding technology and the non-companding Precoder Codebook technique requiring the same 5-bit/use feedback information, it can be verified that the Closed-Loop Knockdown Precoding technology is much superior to the non-companding Precoder Codebook technique. In addition, the Open-Loop Knockdown Precoding technology requiring 4 bits/use is rather superior to the non-companding Precoder Codebook technique requiring 5 bits/use. However, the companding Precoder Codebook technique shows the similar performance to that of the Closed-Loop Knockdown Precoding technology, but needs further feedback for a spatial correlation matrix of a downlink channel for companding, causing a considerable increase in the required amount of feedback information compared to the Closed-Loop Knockdown Precoding technology.

It can be noted from the simulation result that the Knockdown Precoding technology of the present invention, compared with the conventional Precoder Codebook technique, can be applied to the channel environment having various spatial correlations, and its performance is also superior.

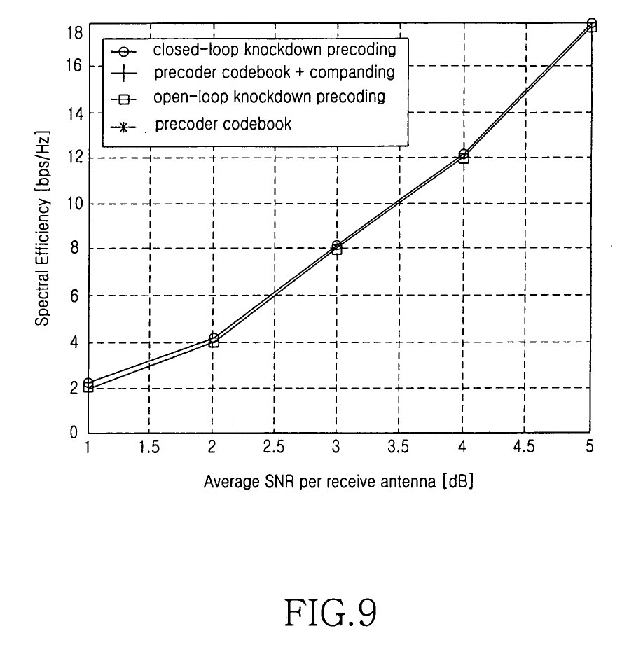

FIG. 9 illustrates a performance comparison result between a Precoder Codebook technique and an MMSE-OSIC system to which the Knockdown Precoding technology, in the no-spatial correlation environment, for n_{T}=n_{R}=4.

Referring to FIG. 9, in the no-correlation (or uncorrelated) environment, the companding Precoder Codebook technique and the non-companding Precoder Codebook technique show the same performance. This is because in the uncorrelated environment, as a transmission correlation matrix is a unit matrix, the precoder codebook remains unchanged even though it undergoes companding. The two Precoder Codebook techniques show the same performance as that of the Closed-Loop Knockdown Precoding technology, and show the slightly higher performance than that of the Open-Loop Knockdown Precoding technology. It can be understood from the performance comparison results of FIGS. 12 and 13 that the Precoder Codebook technique of the present invention, compared to the conventional technique, has no performance difference even in the uncorrelated environment, and has superior performance in the channel environment having various spatial correlations.

As is apparent from the foregoing description, the Knockdown Precoding technology of the present invention, compared to the conventional Precoder Codebook technique, can be applied to the channel environment having various spatial correlations, and has excellent performance, contributing to an increase in the throughput. In addition, the Knockdown Precoding technology requires less memory capacity than the Precoder Codebook technique, and can be optimized according to the uplink channel structure and capacity of the system to which the spatial multiplexing technique is to be applied.

While the invention has been shown and described with reference to a certain preferred embodiment thereof, it will be understood by those skilled in the art that various changes in form and details may be made therein without departing from the spirit and scope of the invention as defined by the appended claims. For example, although the present invention has been described with reference to the system with two transmit antenna and two receive antenna, by way of example, the number of antennas is extensible.

What is claimed is:

1. A method for transmitting feedback information by a receiver in a mobile communication system that performs multiplexing transmission using array antennas, the method comprising:
determining a weight set for maximizing a data rate among at least one weight set having, as its elements, multiple orthonormal weight vectors, based on a fading channel estimated from a pilot channel of received data;
estimating channel state information corresponding to a weight vector of the determined weight set; and
generating and transmitting the feedback information including an index of the determined weight set, selected weight vector information, and channel state information corresponding to the weight vectors.

2. The method of claim 1, wherein the generating and transmitting feedback information comprises:
setting a corresponding Channel Quality Information (CQI) in a channel state information parameter corresponding to a selected weight vector, and setting a channel state information parameter corresponding to an unselected weight vector to ‘NULL’.

3. The method of claim 2, wherein the generating and transmitting feedback information comprises:
arranging the channel state information in a manner of arranging, with a higher priority, a CQI being set such that the CQI is mapped to a selected weight vector, and arranging, with a lower priority, ‘NULL’ being set such that ‘NULL’ is mapped to an unselected weight vector.

4. The method of claim 1, wherein the generating and transmitting feedback information comprises:
generating and transmitting feedback information using a channel state information CQI corresponding to a selected weight vector.

5. A method for receiving feedback information by a transmitter in a mobile communication system that performs multiplexing transmission using array antennas, the method comprising:
receiving a weight set for maximizing a data rate among at least one weight set having, as its elements, multiple orthonormal weight vectors, and selected weight vector information;
receiving sub-channel data stream state information; and
mapping the received sub-channel data stream state information in an order of the selected weight vectors.

6. The method of claim 5, wherein the receiving of the sub-channel data stream state information comprises:
receiving the sub-channel data stream state information using a detection threshold, which is adjusted in proportion to a number of the selected weight vectors.

7. A reception apparatus for transmitting feedback information in a mobile communication system that performs multiplexing transmission using array antennas, the reception apparatus comprising:
a downlink channel estimator for estimating a channel state using a pilot channel of data transmitted from a transmitter;
a weight selector for determining a weight set and a weight vector based on the channel state, and transmitting information on the weight set and the weight vector to the transmitter; and
a sub-channel state estimator for estimating a sub-data channel state according to the determined weight vector, and transmitting the sub-data channel state to the transmitter.

8. The reception apparatus of claim 7, wherein the sub-channel state estimator sets a corresponding Channel Quality Information (CQI) in a channel state information parameter corresponding to a selected weight vector, and sets a channel state information parameter corresponding to an unselected weight vector to ‘NULL’.

9. The reception apparatus of claim 8, wherein the sub-channel state estimator arranges the channel state information in a manner of arranging, with a higher priority, a CQI being set such that the CQI is mapped to a selected weight vector, and arranging, with lower priority, ‘NULL’ being set such that ‘NULL’ is mapped to an unselected weight vector.

10. The reception apparatus of claim 7, wherein the sub-channel state estimator generates and transmits the feedback information using channel state information CQI corresponding to the selected weight vector.
